(19) United States
(12) Patent Application Publication
(10) Pub. No.: US 2025/0239632 A1
(43) Pub. Date: Jul. 24, 2025

(54) RADICALLY CURABLE SEALING MEMBER FOR FUEL CELLS

(71) Applicant: Sumitomo Riko Company Limited, Aichi (JP)

(72) Inventors: Yasunori Nimura, Aichi (JP); Kentaro Imai, Aichi (JP)

(73) Assignee: Sumitomo Riko Company Limited, Aichi (JP)

(21) Appl. No.: 19/174,893

(22) Filed: Apr. 9, 2025

Related U.S. Application Data
(63) Continuation of application No. PCT/JP2023/045327, filed on Dec. 18, 2023.

(30) Foreign Application Priority Data
Jan. 31, 2023 (JP) 2023-012715

(51) Int. Cl. H01M 8/0284

(52) U.S. Cl. CPC H01M 8/0284

(57) ABSTRACT

A radically curable sealing member for fuel cells is formed of a crosslinked body of a radically curable composition which contains the components (A) to (D) described below, with the content of the component (B) being 5 parts by mass to 20 parts by mass with respect to 100 parts by mass of the component (A): (A) a polyisobutylene polymer having a (meth)acryloyl group at a molecular chain end; (B) a polyfunctional (meth)acrylic monomer having 5 or more functional groups; (C) a monofunctional (meth)acrylic monomer; and (D) a radical polymerization initiator.

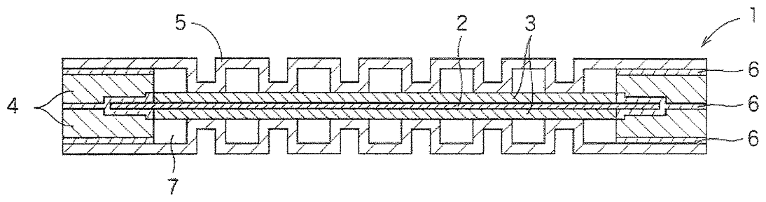

### CROSS-REFERENCE TO RELATED APPLICATION

This application is a continuation of PCT International Application No. PCT/JP2023/045327, filed on Dec. 18, 2023, which claims priority under 35 U.S.C § 119(a) to Japanese Patent Application No. 2023-012715, filed on Jan. 31, 2023. Each of the above application(s) is hereby expressly incorporated by reference, in its entirety, into the present application.

### BACKGROUND

### Technical Field

The present disclosure relates to a radically curable sealing member used for sealing a constituent member of a fuel cell.

### Related Art

Fuel cells generate electricity through an electrochemical reaction of a gas, have high power generation efficiency, and emit a gas that is clean and has extremely low environmental impact. Among the fuel cells, solid polymer fuel cells are capable of operating at relatively low temperatures and have high output density. Hence, the solid polymer fuel cells are expected to have various applications such as for power generation and as power sources for automobiles.

In a solid polymer fuel cell, a cell in which a membrane electrode assembly (MEA) or the like is sandwiched between separators serves as a power generation unit. The MEA includes a polymer membrane (electrolyte film) that serves as an electrolyte, and a pair of electrode catalyst layers (fuel electrode (anode) catalyst layer and oxygen electrode (cathode) catalyst layer) arranged on both sides of the electrolyte film in a thickness direction. On a surface of the pair of electrode catalyst layers, a porous layer for gas diffusion is further arranged. A fuel gas such as hydrogen is supplied to the fuel electrode side, and an oxidizer gas such as oxygen or air is supplied to the oxygen electrode side. Power generation is performed by an electrochemical reaction at a three-phase interface of the gases supplied, electrolyte, and electrode catalyst layers. The solid polymer fuel cell is configured as follows: a cell stack in which a large number of the above cells are stacked is tightened by end plates or the like arranged at both ends in a direction in which the cells are stacked.

In the separator, a flow path for a gas supplied to each electrode or a flow path for a coolant for mitigating heat generated during power generation is formed. For example, if the gases supplied to each electrode mix, problems such as decreased power generation efficiency may occur. The electrolyte film has proton conductivity in a water-containing state. Hence, during operation, it is necessary to maintain the electrolyte film in a wet state. Accordingly, to prevent mixing of gases and leakage of gases and coolant as well as to maintain a wet state inside the cell, it is important to ensure sealing around the MEA and porous layer or between adjacent separators. As a sealing member used to seal these constituent members, a radically curable sealing member containing a polymer such as a polyisobutylene polymer or (meth)acrylic polymer having a (meth)acryloyl group at a molecular chain end, for example, has been proposed (for example, see WO 2017/029978).

A fuel cell is configured, for example, as follows: 200 to 300 cells are stacked, and are fastened while the sealing member as described above is highly compressed (for example, at a compression ratio of 50%). Hence, it is desired that the fuel cell has excellent compression crack resistance (resistance to compression failure).

As a method for improving compression crack resistance, a method for adding silica to a material of the sealing member is conceivable. However, while a tendency can be observed that the compression crack resistance is improved when silica is added to the material of the sealing member, since a silica-derived Si (silicon) component may elute from the sealing member over time, there is concern that, for example, various performances of the sealing member or fuel cell may be affected. Hence, it is desired to develop a new method different from the aforementioned method for adding silica.

### SUMMARY

A radically curable sealing member for fuel cells includes a crosslinked body of a radically curable composition containing the following components (A) to (D), with the content of the component (B) being 5 to 20 parts by mass with respect to 100 parts by mass of the component (A):
(A) a polyisobutylene polymer having a (meth) acryloyl group at a molecular chain end;
(B) a polyfunctional (meth) acrylic monomer having 5 or more functional groups;
(C) a monofunctional (meth) acrylic monomer;
(D) a radical polymerization initiator.

### BRIEF DESCRIPTION OF THE DRAWINGS

The FIGURE is a cross-sectional view showing an example of a radically curable sealing member for fuel cells of the present disclosure used as a sealed body.

### DESCRIPTION OF THE EMBODIMENTS

The present disclosure provides a radically curable sealing member for fuel cells that excels in compression crack resistance.

In the process of conducting diligent research, from the viewpoint of improving compression crack resistance, the present inventors focused on and proceeded with studies on particularly a polyfunctional (meth)acrylate among the materials constituting the sealing member. As a result of further studies from the viewpoint of highly balancing both mechanical strength and elongation properties of the sealing member, the present inventors found the following fact: when a crosslinked body composed of a radically curable composition, which can be obtained by blending a specific polyfunctional (meth)acrylic monomer, namely, a polyfunctional (meth)acrylic monomer having 5 or more functional groups, in a specific content ratio with respect to a polyisobutylene polymer having a (meth)acryloyl group at a molecular chain end, is used as a radically curable sealing member for fuel cells, unexpectedly, an effect of significantly improving compression crack resistance can be obtained.

The present disclosure is summarized in the following [1] to [6].
[1]

A radically curable sealing member for fuel cells, including a crosslinked body of a radically curable composition containing the following components (A) to (D), with the content of the component (B) being 5 to 20 parts by mass with respect to 100 parts by mass of the component (A):
(A) a polyisobutylene polymer having a (meth) acryloyl group at a molecular chain end;
(B) a polyfunctional (meth) acrylic monomer having 5 or more functional groups;
(C) a monofunctional (meth) acrylic monomer;
(D) a radical polymerization initiator.
[2]

The radically curable sealing member for fuel cells according to [1], in which the content of the component (B) is 8 to 20 parts by mass with respect to 100 parts by mass of the component (A).
[3]

The radically curable sealing member for fuel cells according to [1] or [2], in which the component (B) is a polyfunctional (meth)acrylic monomer having 5 or more functional groups including a pentaerythritol skeleton.
[4]

The radically curable sealing member for fuel cells according to any one of [1] to [3], in which the radically curable sealing member for fuel cells has a glass transition temperature of −40° C. or lower.
[5]

The radically curable sealing member for fuel cells according to any one of [1] to [4], in which the radically curable composition is a radically curable composition that does not contain silica.
[6]

The radically curable sealing member for fuel cells according to any one of [1] to [5], in which the radically curable sealing member for fuel cells does not develop cracks after the following compression heat treatment.

### [Compression Heat Treatment]

Compression ratio: 50%
Heating temperature: 120° C.
Heating time: 100 hours

The radically curable sealing member for fuel cells of the present disclosure excels in compression crack resistance. Hence, the radically curable sealing member for fuel cells is able to exhibit excellent performance as a sealing member for fuel cells.

The following describes in detail an embodiment of the present disclosure. However, the present disclosure is not limited to this embodiment.

In the present specification, “(meth)acrylic” is a term used to encompass both acrylic and methacrylic, “(meth)acrylate” is a term used to encompass both acrylate and methacrylate, “(meth)acryloyl group” is a term used to encompass both acryloyl group and methacryloyl group, and “polymer” is a term used to encompass copolymer and oligomer.

As described above, a radically curable sealing member for fuel cells (hereinafter sometimes referred to as “the present sealing member”) according to an embodiment of the present disclosure is a radically curable sealing member for fuel cells which includes a crosslinked body of a radically curable composition (hereinafter sometimes referred to as “the present radically curable composition”) containing components (A) to (D) described below, with the content of the component (B) being 5 to 20 parts by mass with respect to 100 parts by mass of the component (A):
(A) a polyisobutylene polymer having a (meth) acryloyl group at a molecular chain end;
(B) a polyfunctional (meth) acrylic monomer having 5 or more functional groups;
(C) a monofunctional (meth) acrylic monomer;
(D) a radical polymerization initiator.

By using the crosslinked body of the present radically curable composition as the radically curable sealing member for fuel cells, an effect of significantly improving compression crack resistance can be obtained. Although the reason for obtaining such an effect is not necessarily clear, the following is conceivable. By using the crosslinked body of the radically curable composition, which is obtained by blending the polyfunctional (meth)acrylic monomer having 5 or more functional groups (B) in a specific content ratio with respect to the polyisobutylene polymer having a (meth)acryloyl group at a molecular chain end (A), and further blending the monofunctional (meth)acrylic monomer (C) and the radical polymerization initiator (D) therein, both mechanical strength and elongation properties of the sealing member can be highly balanced, resulting in the effect of significantly improving compression crack resistance.

For example, if a polyfunctional (meth)acrylic monomer having 4 or fewer functional groups instead of the component (B) is blended with respect to the sealing member, although the compression crack resistance can be improved to a certain extent, it is difficult to highly balance both mechanical strength and elongation properties. Hence, the effect of significantly improving compression crack resistance cannot be obtained.

Moreover, the present sealing member is highly useful in that the effect of significantly improving compression crack resistance can be obtained even without using silica as a material thereof. That is, there are limited methods for improving the compression crack resistance of the sealing member. In reality, it is assumed to adopt a method for blending silica. However, in the case of using silica as a material of the sealing member, there is concern that a silica-derived Si (silicon) component may elute from the sealing member over time, and various performances of the sealing member or fuel cell may be affected. Since the present sealing member makes it possible to obtain the effect of significantly improving compression crack resistance even without using silica as a material thereof, the concern as described above can be alleviated.

In the case of using silica as a material of the sealing member, since there is a tendency that variations occur in various properties of the sealing member due to variations in particle size or surface state of silica, concern may be raised concerning quality stability. However, in the present sealing member, since excellent compression crack resistance can be exhibited even without using silica, excellent quality stability can be achieved.

Furthermore, in the case of using silica as a material of the sealing member, due to aggregation properties of silica, a reasonable amount of work is required for a dispersion treatment process in a production process. However, in the present sealing member, since excellent compression crack resistance can be exhibited even without using silica, the amount of work required for the dispersion treatment can be reduced, and excellent productivity or economic efficiency can be achieved.

The following describes in detail each component or material used in the present sealing member.

### <Component (A)>

The polyisobutylene polymer having a (meth)acryloyl group at a molecular chain end is a main component of the radically curable composition being a material of the present sealing member. The polyisobutylene polymer having a (meth)acryloyl group at a molecular chain end is a component that typically accounts for 50 mass % or more, preferably 50 to 85 mass %, more preferably about 60 to 75 mass % with respect to a total amount (100 mass %) of the above composition. Compared to an acrylic polymer or the like, such a component (A) has excellent hydrolysis resistance and is able to suppress changes (such as decrease in elongation or increase in hardness due to embrittlement) in mechanical properties caused by hydrolysis. Hence, the present sealing member has excellent product durability.

The component (A) may be used alone or in combination of two or more types thereof.

The component (A) may be any polyisobutylene polymer having, at a molecular chain end, a (meth)acryloyl group being a radically curable functional group. From the viewpoint of enhancing radical curability, the component (A) is preferably a polyisobutylene polymer having a (meth)acryloyl group at both ends of a molecular chain thereof.

An average number of (meth)acryloyl groups introduced per molecule of the component (A) is not particularly limited, and is, for example, preferably 1.5 to 4, more preferably 1.7 to 2.5.

A glass transition temperature (Tg) of the component (A) is not particularly limited, and is, for example, preferably −40° C. or lower, more preferably −50° C. or lower. If the glass transition temperature (Tg) of the component (A) is higher than the above temperature, a tendency can be observed that low temperature sealability deteriorates. A lower limit of the glass transition temperature (Tg) of the component (A) is not particularly limited, and is, for example, −80° C. or higher.

The glass transition temperature (Tg) of the component (A) can be measured by a known method, for example, by a differential scanning calorimeter (DSC). Specifically, a sample is cooled to −90° C. and then subjected to measurement using a differential scanning calorimeter (DSC) SSC-5200 (manufactured by Seiko Instruments Inc.) for a period during which the sample is heated to 200° C. at a temperature rise rate of 20° C./min, thus obtaining a DSC curve from which the glass transition temperature is obtained.

From the viewpoint of remarkably achieving the effects of the present disclosure, a number average molecular weight (Mn) of the component (A) is, for example, preferably 2000 to 100000, more preferably 3000 to 50000. If the number average molecular weight (Mn) is smaller than the above range, a tendency can be observed that compression crack resistance deteriorates.

From the viewpoint of remarkably achieving the effects of the present disclosure, a molecular weight distribution (weight average molecular weight (Mw)/number average molecular weight (Mn)) of the component (A) is, for example, preferably 1.1 to 1.6, more preferably 1.1 to 1.4.

The above number average molecular weight (Mn) and weight average molecular weight (Mw) are measured by gel permeation chromatography (GPC). Specifically, chloroform is used as the mobile phase, the measurement is performed using a polystyrene gel column, and the number average molecular weight or the like can be obtained by polystyrene conversion.

From the viewpoint of remarkably achieving the effects of the present disclosure, viscosity (viscosity measured by an E-type viscometer) of the component (A) at 23° C. is, for example, preferably 100 to 10000 Pa·s, more preferably 500 to 6000 Pa·s, and even more preferably 1000 to 5000 Pa·s.

A specific structure of the component (A) is not particularly limited if the component (A) is a polymer having a (meth)acryloyl group at a molecular chain end and having a polyisobutylene skeleton (—[CH₂C(CH₃)₂]n—, where n=2 or more). Examples thereof include known structures having the structures shown in formulas (1) to (4) below.

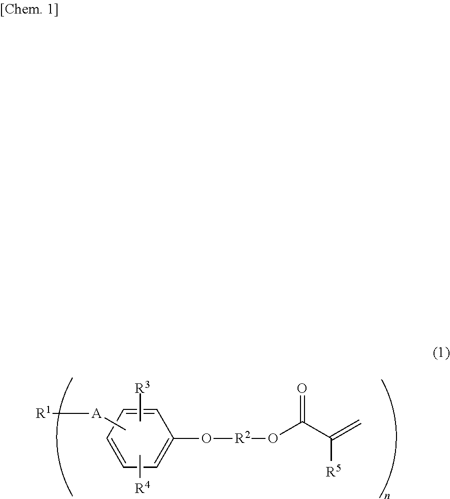

In formula (1), R¹ represents a divalent or higher aromatic hydrocarbon group or an aliphatic hydrocarbon group; A represents a polyisobutylene skeleton containing —[CH₂C(CH₃)₂]— units; R² represents a divalent saturated hydrocarbon group having 2 to 6 carbon atoms and does not contain heteroatoms; R³ and R⁴ each independently represent hydrogen, a monovalent hydrocarbon group having 1 to 20 carbon atoms, or an alkoxy group; R⁵ represents hydrogen or a methyl group; and n represents an integer of 2 or more.

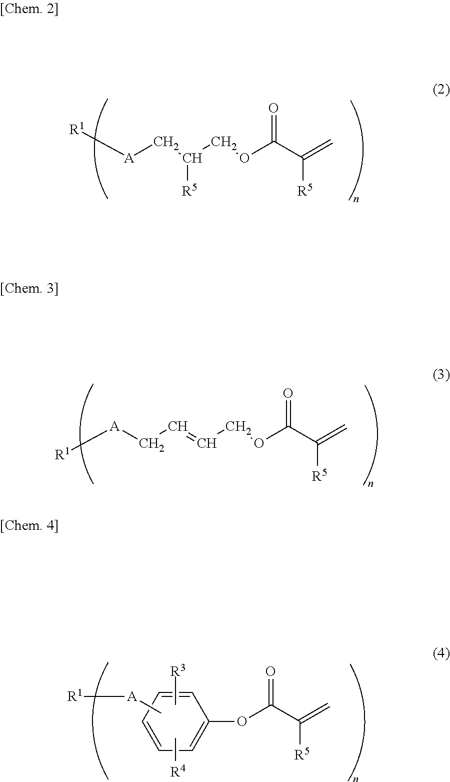

In formulas (2) to (4), R¹ represents a divalent or higher aromatic hydrocarbon group or an aliphatic hydrocarbon group; A represents a polyisobutylene skeleton containing —[CH₂C(CH₃)₂]— units; R³ and R⁴ each independently represent hydrogen, a monovalent hydrocarbon group having 1 to 20 carbon atoms, or an alkoxy group; R⁵ represents hydrogen or a methyl group; and n represents an integer of 2 or more.

The component (A) may be a synthetic product or a commercially available product. Examples of the commercially available product include EP400V produced by Kaneka Corporation. Examples of a method for synthesizing (producing) the component (A) include known methods described in Japanese Patent Laid-Open No. 2013-035901 and International Publication No. WO 2013/047314.

### <Component (B)>

The (B) pentafunctional or higher polyfunctional (meth)acrylic monomer refers to a (meth)acrylate compound having 5 or more (meth)acryloyl groups within a molecular structure. As described above, from the viewpoint of exhibiting excellent compression crack resistance, it is important that the present radically curable composition contains (B) a pentafunctional or higher polyfunctional (meth)acrylic monomer, and that the content of the component (B) is 5 to 20 parts by mass with respect to 100 parts by mass of the component (A).

The component (B) is not limited to the following, and is preferably a pentafunctional or higher polyfunctional (meth)acrylic monomer having a pentaerythritol skeleton from the viewpoint of remarkably achieving the effects of the present disclosure. A pentafunctional or higher polyfunctional (meth)acrylic monomer having a pentaerythritol skeleton refers to a compound having one or more pentaerythritol skeletons (skeletal portion of pentaerythritol: C(CH₂—O—)₄ residue) in a molecule and having 5 or more (meth)acryloyl groups in a molecule.

Specific examples of the component (B) include, but not limited to: dipentaerythritol penta(meth)acrylate, tripentaerythritol penta(meth)acrylate, dipentaerythritol hexa(meth)acrylate, tripentaerythritol hexa(meth)acrylate, tripentaerythritol hepta(meth)acrylate, tripentaerythritol octa(meth)acrylate, tetrapentaerythritol nona(meth)acrylate, tetrapentaerythritol deca(meth)acrylate, and alkylene oxide-modified compounds thereof. Among them, dipentaerythritol pentaacrylate and dipentaerythritol hexaacrylate are preferable.

One of these components (B) may be used alone, or two or more thereof may be used in combination.

As described above, from the viewpoint of achieving the effects of the present disclosure, it is important that the content of the component (B) is 5 to 20 parts by mass with respect to 100 parts by mass of the component (A). The content of the component (B) can be appropriately set within the above range. From the viewpoint of remarkably achieving the effects of the present disclosure, the content is preferably 6 to 20 parts by mass, more preferably 8 to 20 parts by mass, and particularly preferably 10 to 15 parts by mass, with respect to 100 parts by mass of the component (A).

The present sealing member may contain, as the polyfunctional (meth)acrylic monomer, a polyfunctional (meth)acrylic monomer having 2 to 4 functional groups, within a range of not impairing the effects of the present disclosure. However, the content of the polyfunctional (meth)acrylic monomer having 2 to 4 functional groups is preferably 5 parts by mass or less, more preferably 3 parts by mass or less, with respect to 100 parts by mass of the component (A). If the content of the polyfunctional (meth)acrylic monomer having 2 to 4 functional groups exceeds the above range, there is a tendency that compression crack resistance deteriorates.

The above polyfunctional (meth)acrylic monomer having 2 to 4 functional groups is a (meth)acrylate compound having 2 to 4 (meth)acryloyl groups within a molecular structure. Specific examples of the polyfunctional (meth)acrylic monomer having 2 to 4 functional groups include: alkanediol di(meth)acrylate, such as 1,6-hexanediol di(meth)acrylate, 1,8-octanediol di(meth)acrylate, 1,9-nonanediol di(meth)acrylate, 1,10-decanediol di(meth)acrylate, 1,12-dodecanediol di(meth)acrylate, 3-methyl-1,5-pentanediol di(meth)acrylate, 2,4-diethyl-1,5-pentanediol di(meth)acrylate, butylethylpropanediol di(meth)acrylate, 3-methyl-1,7-octanediol di(meth)acrylate, 2-methyl-1,8-octanediol di(meth)acrylate, and neopentyl glycol di(meth)acrylate; ethoxylated cyclohexane dimethanol di(meth)acrylate; ethoxylated bisphenol A di(meth)acrylate; tricyclodecane dimethanol di(meth)acrylate; propoxylated ethoxylated bisphenol A di(meth)acrylate; and 1,1,1-trishydroxymethylethane di(meth)acrylate.

Other examples include trimethylolpropane tri(meth)acrylate, trimethylolpropane ethoxy tri(meth)acrylate, trimethylolpropane propoxy tri(meth)acrylate, glycerin propoxy tri(meth)acrylate, tetramethylolmethane tri(meth)acrylate, tetramethylolmethane tetra(meth)acrylate, and ditrimethylolpropane tetra(meth)acrylate.

### <Component (C)>

The monofunctional (meth)acrylic monomer being the component (C) is a (meth)acrylate compound having one (meth)acryloyl group within a molecular structure. Specifically, examples include known ethylenically unsaturated monofunctional monomers, such as but not limited to, an acrylic acid alkyl ester monomer, such as methyl (meth)acrylate, ethyl (meth)acrylate, n-propyl (meth)acrylate, n-butyl (meth)acrylate, isobutyl (meth)acrylate, t-butyl (meth)acrylate, n-pentyl (meth)acrylate, n-heptyl (meth)acrylate, 2-ethylhexyl (meth)acrylate, n-octyl (meth)acrylate, isooctyl (meth)acrylate, nonyl (meth)acrylate, isononyl (meth)acrylate, decyl (meth)acrylate, isodecyl acrylate, lauryl (meth)acrylate, tridecyl (meth)acrylate, stearyl (meth)acrylate, isostearyl (meth)acrylate, isobornyl (meth)acrylate, cyclohexyl (meth)acrylate, benzyl (meth)acrylate, and phenoxyethyl (meth)acrylate. Among them, n-octyl acrylate, 2-ethylhexyl acrylate, nonyl acrylate, and isodecyl acrylate are preferable, and 2-ethylhexyl acrylate is more preferable.

One of these components (C) may be used alone, or two or more thereof may be used in combination.

The content of the component (C) is not particularly limited, and is, for example, preferably 5 to 70 parts by mass, more preferably 10 to 50 parts by mass, with respect to 100 parts by mass of the component (A).

A glass transition temperature (Tg) of the component (C) is not particularly limited, and is preferably −40° C. or lower, more preferably −50° C. or lower. If the glass transition temperature (Tg) of the component (C) is higher than the above temperature, a tendency can be observed that low temperature sealability deteriorates. A lower limit of the glass transition temperature (Tg) is not particularly limited, and is, for example, −80° C. or higher.

The glass transition temperature (Tg) of such a component (C) can be obtained by measuring a homopolymer of the monofunctional (meth) acrylic monomer being the component (C) in the same manner as described above using a differential scanning calorimeter (DSC).

### <Component (D)>

The radical polymerization initiator being the component (D) is not particularly limited if it is any compound that generates radicals by irradiation with an active energy ray. Specific examples of the component (D) include, but not limited to: a benzophenone type compound, such as benzophenone, 4-methylbenzophenone, 2,4,6-trimethylbenzophenone, methyl orthobenzoylbenzoate, and 4-phenylbenzophenone; an anthraquinone type compound, such as t-butylanthraquinone and 2-ethylanthraquinone; an alkylphenone type compound, such as 2-hydroxy-2-methyl-1-phenylpropan-1-one, oligo{2-hydroxy-2-methyl-1-[4-(1-methylvinyl)phenyl]propanone}, benzyl dimethyl ketal, 1-hydroxycyclohexyl phenyl ketone, benzoin methyl ether, 2-methyl-[4-(methylthio)phenyl]-2-morpholino-1-propanone, and 2-hydroxy-1-{4-[4-(2-hydroxy-2-methylpropionyl)benzyl]phenyl}-2-methylpropan-1-one; 2-benzyl-2-dimethylamino-1-(4-morpholinophenyl)-butanone-1; a thioxanthone type compound, such as diethylthioxanthone and isopropylthioxanthone; an acylphosphine oxide type compound, such as 2,4,6-trimethylbenzoyl diphenylphosphine oxide, bis(2,6-dimethoxybenzoyl) -2,4,4-trimethylpentylphosphine oxide, and bis(2,4,6-trimethylbenzoyl)-phenylphosphine oxide; and a phenyl glyoxylate type compound, such as phenylglyoxylic acid methyl ester. Among them, from the viewpoint of excellent reactivity, an alkylphenone type compound is preferable, and 2-hydroxy-2-methyl-1-phenylpropan-1-one or the like is more preferable.

One of these components (D) may be used alone, or two or more thereof may be used in combination.

The content of the component (D) is not particularly limited, and is, for example, preferably 0.01 to 10 parts by mass, more preferably 0.1 to 5 parts by mass, with respect to 100 parts by mass of the component (A).

### (Silica)

The present radically curable composition being a material of the present sealing member may contain silica in addition to the above components (A) to (D). However, since there is a risk that a silica-derived Si component may elute from the sealing member over time and physical properties of the sealing member or various performances of the fuel cell may be adversely affected, it is preferable that the present radically curable composition does not contain silica.

In the case where the radically curable composition contains silica, the content thereof is preferably less than 8 mass %, more preferably less than 5 mass %, even more preferably less than 1 mass %, particularly preferably less than 0.5 mass %, and most preferably 0 mass %, with respect to the total amount (100 mass %) of the present radically curable composition.

Examples of the above silica include silica surface-treated with a silane compound, dimethylsilylated silica surface-treated with dimethylsilane, trimethylsilylated silica surface-treated with trimethylsilane, octylsilylated silica surface-treated with octylsilane, and methacrylsilylated silica surface-treated with methacryloxysilane.

### <Various Additives>

In addition to the above components (A) to (D), various additives, such as a filler other than silica, an anti-aging agent, a compatibilizer, a curability adjusting agent, a lubricant, a pigment, a defoaming agent, a foaming agent, a light stabilizer, and a surface modifier, may be blended in the present radically curable composition, within a range of not impairing the effects of the present disclosure.

Since there is a risk of inhibiting power generation of the fuel cell or contaminating a platinum catalyst of the fuel cell, it is desirable that the present radically curable composition does not include materials such as amines, sulfur, and phosphorus-based materials.

### <Method for Producing Radically Curable Composition>

The present radically curable composition is produced by adding the components (A) to (D) and other components, and mixing and stirring the same using a mixer such as a planetary mixer.

### <Curing Method (Crosslinking Method)>

The present radically curable composition is cured (crosslinked) by an active energy ray such as an electron beam or an ultraviolet ray. Among them, an ultraviolet ray, which causes little damage to a substrate, is preferable. An active energy source is not particularly limited and may be a known source. For example, a high pressure mercury lamp, a blacklight, an LED, or a fluorescent lamp may be preferably used.

### <Glass Transition Temperature (Tg) of Present Sealing Member>

From the viewpoint of remarkably achieving the effects of the present disclosure, the present sealing member that includes a crosslinked body of the present radically curable composition has a glass transition temperature (Tg) of preferably −40° C. or lower, more preferably −50° C. or lower. If the glass transition temperature (Tg) is higher than the above temperature, a tendency can be observed that low temperature sealability deteriorates. A lower limit of the glass transition temperature (Tg) of the present sealing member is not particularly limited, and is, for example, −80° C. or higher.

The glass transition temperature (Tg) of the present sealing member is measured by a differential scanning calorimeter (DSC) in the same manner as described above.

### <Compression Crack Resistance of Present Sealing Member>

The present sealing member that includes the crosslinked body of the present radically curable composition exhibits excellent compression crack resistance. For example, the present sealing member does not develop cracks even after a compression heat treatment described below.

### [Compression Heat Treatment]

Compression ratio: 50%
Heating temperature: 120° C.
Heating time: 100 hours

It is preferable that the present sealing member that includes the crosslinked body of the present radically curable composition does not develop cracks even in the case where the compression ratio is changed to 60% in the above compression heat treatment.

### <Elongation at Break (Eb) of Present Sealing Member>

The present sealing member that includes the crosslinked body of the present radically curable composition has good elongation properties. For example, the present sealing member has an elongation at break (Eb) of 100% or more, preferably 140% or more, more preferably 150% or more, as measured in accordance with JIS K 6251 under an atmosphere of 23° C.

<Si Elution Amount (ppm) and Volume Change Rate (%) of Present Sealing Member>

The present sealing member, even without silica being blended into the radically curable composition as a material thereof, exhibits excellent compression crack resistance. Accordingly, for example, the present sealing member has an Si elution amount of less than 1 ppm, more preferably less than 0.1 ppm, and even more preferably less than 0.01 ppm, in which the Si elution amount is obtained by a method to be described later in the examples.

For example, it is preferable that the present sealing member has a volume change rate (%) within a range of 98% to 102%, in which the volume change rate is obtained by a method to be described later in the examples.

### <Sealing Method>

A sealing method for the above radically curable composition includes, for example, applying the radically curable composition to a constituent member of a fuel cell, followed by irradiation with an active energy ray for curing. As an application method, various methods such as a dispenser, a spray, inkjet, and screen printing can be used. More specifically, sealing methods such as a formed-in-place gasket (FIPG), a cure-in-place gasket (CIPG), and a mold-in-place gasket (MIPG) can be used.

Since the above radically curable composition can be crosslinked in a short time (for example, about several tens of seconds), by sealing the constituent member of the fuel cell using the above radically curable composition in accordance with the above sealing method, excellent productivity can be achieved. The present sealing member can be easily made into a film-like sealing member. By making the sealing member into a thin film, the fuel cell can be reduced in size.

### <Applications>

The present sealing member that includes the crosslinked body of the above radically curable composition may be used in a constituent member of a fuel cell.

### <Preparation of Present Sealing Member (Radically Curable Sealing Member for Fuel Cells)>

The present sealing member can be prepared by the following method. A composition containing the components (A) to (D) and, if necessary, other components, is prepared. Then, for example, the composition is applied to various constituent members such as a separator of a fuel cell using a dispenser, and irradiated with an active energy ray and cured.

The present sealing member can also be prepared by the following method. The above radically curable composition is applied to a surface of various constituent members of a fuel cell on which an adhesive has been applied, and the surface is irradiated with an active energy ray and cured. Furthermore, the present sealing member can also be formed into a predetermined shape in advance according to the shape of a sealing target portion of various constituent members of a fuel cell. For example, if formed into a film-like shape, the sealing member can be attached to various constituent members of a fuel cell using an adhesive for use.

Depending on the type and structure of the fuel cell, there are a variety of constituent members of the fuel cell to be sealed by the present sealing member. Examples include a separator (such as metal separator or carbon separator), a gas diffusion layer, and an MEA (electrolyte film or electrode).

The FIGURE shows an example of forming the present sealing member into a sealed body. The FIGURE mainly shows a single cell 1 in a fuel cell obtained by stacking multiple cells. The cell 1 includes an MEA 2, a gas diffusion layer 3, a sealing member 4, a separator 5, and an adhesive layer 6. The sealing member 4 is the present sealing member.

Examples of a constituent member for fuel cells may include one obtained by adhering the separator 5 and the sealing member 4 via the adhesive layer 6 and one obtained by adhering the separator 5 and the sealing member 4 that is self-adhesive.

Although not illustrated, the MEA 2 includes an electrolyte film and a pair of electrodes arranged on both sides of the electrolyte film in a stacking direction. The electrolyte film and the pair of electrodes are of a rectangular thin plate shape. The gas diffusion layer 3 is arranged on both sides of the MEA 2 in the stacking direction. The gas diffusion layer 3 is a porous layer and is of a rectangular thin plate shape.

The separator 5 is preferably a carbon separator or made of metal. From the viewpoint of conduction reliability, the separator 5 is particularly preferably a metal separator having a carbon thin film such as a diamond-like carbon (DLC) film or a graphite film. The separator 5 is of a rectangular thin plate shape, on which a large number of grooves extending in a longitudinal direction are provided in a depressed manner. Due to these grooves, a cross-section of the separator 5 is of an uneven shape. The separator 5 is arranged facing each other on both sides of the gas diffusion layer 3 in the stacking direction. Between the gas diffusion layer 3 and the separator 5, a gas flow path 7 for supplying a gas to an electrode is marked out utilizing the uneven shape.

The sealing member 4 is of a rectangular frame shape. The sealing member 4 is adhered to a peripheral part of the MEA 2 or the gas diffusion layer 3 and to the separator 5 via the adhesive layer 6, thus sealing the peripheral part of the MEA 2 or the gas diffusion layer 3. In the example of the FIGURE, the sealing member 4 is divided into two members, namely upper and lower members, for use. However, it is also possible to combine these two members into a single sealing member as the sealing member 4.

Examples of a material for forming the adhesive layer 6 include rubber glue, a rubber composition that is liquid at room temperature (23° C.), and a primer. Examples of a method for applying the above material include application using a dispenser. Typically, application may be performed under room temperature conditions. In the case where the above liquid rubber composition is used, the adhesive layer 6 has a thickness of typically 0.01 to 1 mm.

During operation of a fuel cell such as a solid polymer fuel cell, a fuel gas and an oxidizer gas are each supplied through the gas flow path 7. Here, the peripheral part of the MEA 2 is sealed by the sealing member 4 via the adhesive layer 6. Hence, gas mixing or leakage does not occur.

### Examples

The following describes examples along with comparative examples. However, the present disclosure is not limited to these examples as long as the gist thereof is not exceeded.

First, prior to the examples and comparative examples, the following materials were prepared.

Each numerical value (such as measured value) shown for each material was obtained in accordance with the criteria described above.

### <(A) Component>

(a1) Polyisobutylene polymer having an acryloyl group at a molecular chain end (produced by Kaneka Corporation, EP400V)

### <(B) Component>

(b1) Dipentaerythritol pentaacrylate (produced by Shin Nakamura Chemical Co., Ltd., A-DPH)
(b2) Dipentaerythritol hexaacrylate (produced by Shin Nakamura Chemical Co., Ltd., A-9550)
(b3) Polypentaerythritol polyacrylate (produced by Shin Nakamura Chemical Co., Ltd., TPOA-50)
   <(B′) Component (Polyfunctional (Meth)Acrylic Monomer having 2 to 4 Functional Groups)>
(b′1) Trimethylolpropane triacrylate (produced by Osaka Organic Chemical Industry Ltd., Viscoat #295)
(b′2) Ditrimethylolpropane tetraacrylate (produced by Shin Nakamura Chemical Co., Ltd., AD-TMP)

### (C) Component>

(c1) 2-ethylhexyl acrylate (produced by Osaka Organic Chemical Industry Ltd., 2EHA)

### < (D) Component>

(d1) 2-hydroxy-2-methyl-1-phenylpropan-1-one (produced by iGM Resins, Omnirad 1173)

### <Other Components>

Methacrylsilylated silica

### [Examples 1 to 10 and Comparative Examples 1 to 8]

### (Preparation of Radically Curable Sealing Member for Fuel Cells (Test Sample))

The components shown in Table 1 below were blended in the mass ratios shown in Table 1 and kneaded using a planetary mixer (manufactured by Inoue Mfg., Inc.), thereby preparing a radically curable composition.

Subsequently, the radically curable composition was applied to a predetermined thickness using a bar coater, and was irradiated with ultraviolet light (irradiation intensity: 250 mW/cm², cumulative light amount: 3000 mJ/cm²) using a high pressure mercury UV irradiation device (manufactured by Heraeus, F600V-10) to produce a sheet.

### <Compression Crack Resistance>

The above-prepared sheet was punched out to obtain test samples each having a diameter of 10 mm and a thickness of 1 mm and having a circular shape in plan view. The compression crack resistance of each test sample like this was evaluated in accordance with JIS K 6262 (2007). That is, each test sample was compressed at a compression ratio of 50% or 60%, and heated at 120° C. for 100 hours in that state. Then, each test sample after being released from compression was visually confirmed for the presence or absence of cracks therein and was evaluated according to the following criteria. The results thereof are shown in Table 1. The term “cracks” means the occurrence of cracks in the appearance of each test sample.

### [Evaluation Criteria]

⊚ (excellent): No cracks are observed at a compression ratio of 60%.
○ (very good): Cracks are observed at a compression ratio of 60%, and no cracks are observed at a compression ratio of 50%.
x (poor): Cracks are observed at a compression ratio of 50%.

### <Si Elution Amount>

A test piece of a size of 30 mm in width, 50 mm in length, and 1 mm in thickness was cut out from the above-prepared sheet, and each test sample was obtained. Each test sample like this was immersed in a sulfuric acid aqueous solution (pH 3, temperature: 95° C., 100 mL) for 1000 hours, was measured for the Si elution amount after immersion by an inductively coupled plasma (ICP) analysis method, and was evaluated according to the following criteria. The results thereof are shown in Table 1.

### [Evaluation Criteria]

⊚ (excellent): Si elution amount is less than 0.01 ppm.
○ (very good): Si elution amount is 0.01 ppm or more and less than 0.1 ppm.
x (poor): Si elution amount is 0.1 ppm or more.

### <Volume Change Rate>

A test piece of a size of 30 mm in width, 50 mm in length, and 1 mm in thickness was cut out from the above-prepared sheet, and each test sample was obtained. Each test sample like this was immersed in hot water (95° C., 100 mL) for 1000 hours. A volume change rate was calculated from the volume V1 before immersion and the volume V2 after immersion, and was evaluated according to the following criteria. The results thereof are shown in Table 1.

Volume change rate (%)=(volume V2 after immersion)=(volume V1 before immersion)×100

### [Evaluation Criteria]

○ (very good): The volume change rate is 98% or more and 102% or less.
x (poor): The volume change rate is less than 98% or more than 102%.

### <Elongation at Break (Eb)>

The elongation at break (Eb) was evaluated in accordance with JIS K 6251 (2017). That is, with respect to each test sample of a dumbbell shape obtained by cutting out from the above-prepared sheet, the elongation at break (Eb) was measured in an atmosphere of 23° C. and was evaluated according to the following criteria. The results thereof are shown in Table 1.

### [Evaluation Criteria]

⊚ (excellent): Eb value is 140% or more.
○ (very good): Eb value is less than 140% and 100% or more.
x (poor): Eb value is less than 100%.
   <Glass transition Temperature (Tg)>

With respect to each test sample cut out from the above-prepared sheet, the glass transition temperature (Tg) was measured using a differential scanning calorimeter (DSC). The results thereof are shown in Table 1.

TABLE 1
(parts by mass)

| | | Example | | | | | | | | | | Comparative Example | | | | | | | |
|---|---|---|---|---|---|---|---|---|---|---|---|---|---|---|---|---|---|---|---|
| | | 1 | 2 | 3 | 4 | 5 | 6 | 7 | 8 | 9 | 10 | 1 | 2 | 3 | 4 | 5 | 6 | 7 | 8 |
| A | (a1) Poly- | 100 | 100 | 100 | 100 | 100 | 100 | 100 | 100 | 100 | 100 | 100 | 100 | 100 | 100 | 100 | 100 | 100 | 100 |
| | isobutylene | | | | | | | | | | | | | | | | | | |
| | polymer | | | | | | | | | | | | | | | | | | |
| | having | | | | | | | | | | | | | | | | | | |
| | acryloyl | | | | | | | | | | | | | | | | | | |
| | group at | | | | | | | | | | | | | | | | | | |
| | molecular | | | | | | | | | | | | | | | | | | |
| | chain end | | | | | | | | | | | | | | | | | | |
| B | (b1) Dipenta- | 10 | 5 | 8 | 20 | — | — | — | — | 10 | 10 | — | 30 | — | — | — | — | — | — |
| | erythritol | | | | | | | | | | | | | | | | | | |
| | pentaacrylate | | | | | | | | | | | | | | | | | | |
| | (b2) Dipenta- | — | — | — | — | 10 | 20 | — | — | — | — | — | — | — | — | — | — | — | — |
| | erythritol | | | | | | | | | | | | | | | | | | |
| | hexaacrylate | | | | | | | | | | | | | | | | | | |
| | (b3) Poly- | — | — | — | — | — | — | 10 | 20 | — | — | — | — | — | — | — | — | — | — |
| | penta- | | | | | | | | | | | | | | | | | | |
| | erythritol | | | | | | | | | | | | | | | | | | |
| | polyacrylate | | | | | | | | | | | | | | | | | | |
| B | (b′1) Trime | — | — | — | — | — | — | — | — | — | — | — | — | 5 | 10 | — | — | — | — |
| | thylolpropane | | | | | | | | | | | | | | | | | | |
| | triacrylate | | | | | | | | | | | | | | | | | | |
| | (b′2) Ditrime- | — | — | — | — | — | — | — | — | — | — | — | — | — | — | 5 | 10 | — | 5 |
| | thylolpropane | | | | | | | | | | | | | | | | | | |
| | tetraacrylate | | | | | | | | | | | | | | | | | | |
| C | (c1) 2- | 30 | 30 | 30 | 30 | 30 | 30 | 30 | 30 | 10 | 50 | 30 | 30 | 30 | 30 | 30 | 30 | 30 | 30 |
| | ethylhexyl | | | | | | | | | | | | | | | | | | |
| | acrylate | | | | | | | | | | | | | | | | | | |
| D | (d1) 2- | 2 | 2 | 2 | 2 | 2 | 2 | 2 | 2 | 2 | 2 | 2 | 2 | 2 | 2 | 2 | 2 | 2 | 2 |
| | hydroxy- | | | | | | | | | | | | | | | | | | |
| | 2-methyl-1- | | | | | | | | | | | | | | | | | | |
| | phenyl- | | | | | | | | | | | | | | | | | | |
| | propan- | | | | | | | | | | | | | | | | | | |
| | 1-one | | | | | | | | | | | | | | | | | | |
| | Methacryl- | — | — | — | — | — | — | — | — | — | — | — | — | — | — | — | — | 15 | 15 |
| | silylated | | | | | | | | | | | | | | | | | | |
| | silica | | | | | | | | | | | | | | | | | | |
| | Compression | ⊚ | ⊚ | ⊚ | ⊚ | ⊚ | ⊚ | ⊚ | ⊚ | ⊚ | ⊚ | X | X | X | X | X | X | ◯ | X |
| | crack | | | | | | | | | | | | | | | | | | |
| | resistance | | | | | | | | | | | | | | | | | | |
| | (50% or 60% | | | | | | | | | | | | | | | | | | |
| | compressed, | | | | | | | | | | | | | | | | | | |
| | 120° C. × | | | | | | | | | | | | | | | | | | |
| | 100 Hr) | | | | | | | | | | | | | | | | | | |
| | Glass | −48 | −48 | −48 | −47 | −47 | −47 | −49 | −48 | −47 | −50 | −49 | −47 | −46 | −44 | −49 | −48 | −48 | −48 |
| | transition | | | | | | | | | | | | | | | | | | |
| | temperature | | | | | | | | | | | | | | | | | | |
| | (Tg: ° C.) | | | | | | | | | | | | | | | | | | |
| | Elongation | 170 | 180 | 180 | 170 | 160 | 150 | 180 | 180 | 160 | 170 | 200 | 150 | 130 | 100 | 100 | 60 | 160 | 100 |
| | at break | ⊚ | ⊚ | ⊚ | ⊚ | ⊚ | ⊚ | ⊚ | ⊚ | ⊚ | ⊚ | ⊚ | ⊚ | ◯ | ◯ | ◯ | X | ⊚ | ◯ |
| | (Eb: %) | | | | | | | | | | | | | | | | | | |
| | Si elution | ⊚ | ⊚ | ⊚ | ⊚ | ⊚ | ⊚ | ⊚ | ⊚ | ⊚ | ⊚ | ⊚ | ⊚ | ⊚ | ⊚ | ⊚ | ⊚ | X | X |
| | amount | | | | | | | | | | | | | | | | | | |
| | (ppm) | | | | | | | | | | | | | | | | | | |
| | Volume | ◯ | ◯ | ◯ | ◯ | ◯ | ◯ | ◯ | ◯ | ◯ | ◯ | ◯ | ◯ | ◯ | ◯ | ◯ | ◯ | X | X |
| | change | | | | | | | | | | | | | | | | | | |
| | rate (%) | | | | | | | | | | | | | | | | | | |

From the results shown in Table 1 above, it is known that the sealing members of Examples that satisfied each requirement defined in the present disclosure all had excellent compression crack resistance.

From the results shown in Table 1 above, it is known that the sealing members of Examples that satisfied each requirement defined in the present disclosure all obtained favorable results in each evaluation of elongation at break, Si elution amount, and volume change rate.

In contrast, the sealing members of Comparative Examples 1 and 3 to 6 did not contain the (B) polyfunctional (meth)acrylic monomer having 5 or more functional groups defined in the present disclosure. As a result, it is known that the sealing members of Comparative Examples 1 and 3 to 6 were inferior in compression crack resistance. While the sealing member of Comparative Example 2 contained the (B) polyfunctional (meth)acrylic monomer having 5 or more functional groups defined in the present disclosure, the (B) polyfunctional (meth)acrylic monomer having 5 or more functional groups was contained in the range of 30 parts by mass with respect to 100 parts by mass of the component (A). As a result, it is known that the sealing member of Comparative Example 2 was inferior in compression crack resistance.

The sealing members of Comparative Examples 7 to 8 did not contain the (B) polyfunctional (meth)acrylic monomer having 5 or more functional groups defined in the present disclosure and contained silica. As a result, although an effect of improving in compression crack resistance is recognized, it is known that the Si elution amount (ppm) and volume change rate (%) were increased.

In the above examples, specific embodiments of the present disclosure are shown. However, the above examples are merely illustrative and should not be interpreted as limiting. Various modifications that are apparent to those skilled in the art are intended to be within the scope of the present disclosure.

The sealing member of the present disclosure may be used in a member that constitutes a fuel cell. For example, the sealing member of the present disclosure may be used in a fuel cell sealed body in which a fuel cell constituent member such as a metal separator and a rubber sealing member that seals the fuel cell constituent member are adhered via an adhesive layer, or in the sealing member of a fuel cell sealed body in which the sealing members are adhered to each other via an adhesive layer.

1. A radically curable sealing member for fuel cells, comprising a crosslinked body of a radically curable composition containing components (A) to (D), with a content of the component (B) being 5 to 20 parts by mass with respect to 100 parts by mass of the component (A):
(A) a polyisobutylene polymer having a (meth)acryloyl group at a molecular chain end;
(B) a polyfunctional (meth)acrylic monomer having 5 or more functional groups;
(C) a monofunctional (meth) acrylic monomer;
(D) a radical polymerization initiator.

2. The radically curable sealing member for fuel cells according to claim 1, wherein the content of the component (B) is 8 to 20 parts by mass with respect to 100 parts by mass of the component (A).

3. The radically curable sealing member for fuel cells according to claim 1, wherein the component (B) is a polyfunctional (meth)acrylic monomer having 5 or more functional groups comprising a pentaerythritol skeleton.

4. The radically curable sealing member for fuel cells according to claim 1, wherein the radically curable sealing member for fuel cells has a glass transition temperature of −40° C. or lower.

5. The radically curable sealing member for fuel cells according to claim 1, wherein the radically curable composition is a radically curable composition that does not contain silica.

6. The radically curable sealing member for fuel cells according to claim 1, wherein the radically curable sealing member for fuel cells does not develop cracks after a compression heat treatment under conditions of a compression ratio of 50%, a heating temperature of 120° C., and a heating time of 100 hours.
